(19) United States
(12) Patent Application Publication
(10) Pub. No.: US 2010/0263858 A1
(43) Pub. Date: Oct. 21, 2010

(54) SWELLING SEAL

(75) Inventor: Stephen Chauffe, The Woodlands, TX (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Swellfix B.V., Rijswijk (NL)

(21) Appl. No.: 12/761,629

(22) Filed: Apr. 16, 2010

(30) Foreign Application Priority Data
Apr. 17, 2009 (GB) 0906602.8

(51) Int. Cl. E21B 33/12; C09K 3/10

(52) U.S. Cl. 166/179; 106/33

(57) ABSTRACT

A swelling seal comprises a swellable material configured to swell upon exposure to an activator medium, and a de-emulsifying component configured to encourage separation of at least one constituent phase from an emulsion comprising an activator medium. Once separated, the activating medium may be used to activate the swellable material to swell and establish a seal.

### CROSS-REFERENCES TO RELATED APPLICATIONS

This application claims priority from Great Britain Application No. 0906602.8, filed Apr. 17, 2009 incorporated by reference in its entirety.

### FIELD OF THE INVENTION

The present invention relates to a swelling seal, and in particular to a swelling seal configured to swell within an activator medium forming part of an emulsion. The present invention in particular, though not exclusively, relates to a downhole swelling seal.

### BACKGROUND

Seals and other structures formed of or comprising a swelling material are known in the art. For example, seals, such as packers and the like, for use in a downhole environment include materials which swell upon exposure to an activator. The activator may be composed of a fluid, and often includes oil or water. Such swelling seals are normally configured to swell when exposed to an activator present at the location of use. The activator in this case may be naturally occurring; for example the activator may be present in a fluid produced from a subterranean reservoir. Alternatively, the activator may be artificial; for example a specially formulated fluid used to facilitate a particular operation, such as drilling mud or the like. The type of swelling material is typically chosen in accordance with the intended environment. For example, in environments having a relatively high water content, a water swelling material may be selected. Conversely, in environments having a relatively high oil content, an oil swelling material may be selected.

There are many circumstances, however, where exposure of the activator medium to the swelling material is restricted, for example when the activator medium is held within or forms part of an emulsion. This may result in insufficient exposure to facilitate swelling. For example, many drilling fluids are provided in the form of an emulsion, and similarly production conditions may be such that fluids produced from a reservoir exist in the form of an emulsion.

Taking the specific example of drilling mud, a common type is known as an invert or oil based drilling mud, in which oil is the continuous phase and water is the internal phase; that is, oil is the major component and water is dispersed within the oil. Swelling materials for use in such invert muds are selected to swell in oil, as a water swelling material would be substantially inert in such an environment due to the water being held or trapped within the oil. Similarly, in water based drilling muds water swelling materials are selected, as oil swelling materials would be substantially inert.

Addressing the above problem may require very careful selection of the swelling material according to the particular chemistry of the environment of use. This may require a larger inventory to be maintained, which has associated problems related to storage, cost, shelf-life and the like.

It has been proposed in the art to provide products which contain a combination of different swelling materials which permit swelling in different activators. For example, seals have been proposed which include both water and oil swelling elastomers. However, this can increase the total elastomer volume, which may not be desirable, and may result in the provision of an insufficient expansion ratio for the required application.

### SUMMARY OF THE INVENTION

According to a first aspect of the present invention there is provided a swelling seal comprising:
a swellable material configured to swell upon exposure to an activator medium; and
a de-emulsifying component configured to encourage separation of at least one constituent phase from an emulsion comprising an activator medium.

Accordingly, in use, the de-emulsifying component may encourage at least partial separation of an emulsion within which the swelling seal is at least partially immersed, such that the swelling material may more readily become exposed to an activator medium contained within said emulsion to initiate swelling. In this way, a single type of swelling seal may be utilised in different emulsion environments, eliminating or reducing the requirement and associated problems of specifically selecting a swelling material for a specific environment.

The de-emulsifying component may be configured to encourage separation of an activator medium from an emulsion.

The de-emulsifying component may be configured to encourage separation of an activator medium which defines an internal phase of an emulsion. Accordingly, the de-emulsifying component may permit or encourage release of the activating medium from the emulsion.

The de-emulsifying component may be configured to encourage separation of at least one constituent phase from an emulsion comprising two or more constituent phases. The de-emulsifying component may be configured to separate at least one constituent phase from an emulsion comprising at least one of water and oil. The emulsion may comprise fluids produced from a subterranean reservoir, such as water and hydrocarbons. The emulsion may comprise a manufactured emulsion, such as a wellbore fluid or mud, such as drilling mud, used in a wellbore process. The emulsion may comprise an invert or oil based mud. The emulsion may comprise a water based mud.

The swelling seal may comprise a seal body. The seal body may comprise the swelling material. The seal body may comprise at least a portion of the de-emulsifying component. At least a portion of the de-emulsifying component may be provided separately of the seal body.

The de-emulsifying component may comprise a coating. The de-emulsifying component may comprise a component dispersed throughout the swelling material. The de-emulsifying component may comprise a fluid, solid or any combination thereof. The de-emulsifying component may comprise an apparatus.

The de-emulsifying component may comprise a substance exhibiting de-emulsifying properties. For example, the de-emulsifying component may comprise a composition, material, matter, element, compound or the like configured to encourage separation of an emulsion. For example, the de-emulsifying component may comprise an ionic composition, such as a multivalent ionic composition. Such an ionic composition may encourage separation of an emulsion. The de-emulsifying component may comprise a charge configured to attract a constituent phase of an emulsion. The de-emulsifying component may comprise a chemical composition, such as an acid, alkali or the like configured to encourage separation of an emulsion. The de-emulsifying component may comprise a magnetic material.

The de-emulsifying component may be integrated with the swelling material. For example, the de-emulsifying component may be intimately dispersed throughout the swelling material. Dispersal of the de-emulsifying component may be achieved by intimate mixing during a forming process, for example.

The de-emulsifying component may comprise a coating configured to at least partially cover the swelling material.

The de-emulsifying component may comprise an apparatus. The apparatus may be configured to provide an output for encouraging separation of an emulsion. The output may comprise a signal, such as a wave based signal. The output may comprise an acoustic output. For example, the output may comprise ultrasonic waves. The output may comprise low intensity ultrasonic waves.

The output of the apparatus may comprise an electromagnetic output, such as infrared, microwaves, or the like, or any suitable combination.

The output of the apparatus may comprise an electrical field, such as an alternating electrical field. The output may comprise a magnetic field.

The output of the apparatus may comprise vibrations.

The apparatus may comprise a power source. The power source may comprise a local power source, such as a battery arrangement. The power source may comprise a remote power source, which may be configured to provide power to the apparatus via a transmission path, such as a cable or the like. The apparatus may be configured to accommodate energy transfer by virtue of inductance. This may permit non-contact energy transfer, such as energy transfer from internally to externally of a tubular body.

The apparatus may be configured to be selectively operational. This may permit operation when required. The apparatus may be configured to be continuously operated.

The apparatus may be mounted on the swelling material. The apparatus may be embedded within the swelling material. The apparatus may be provided remotely from the swelling material.

The de-emulsifying component may comprise a transportable component, such as a fluid, solid particles or the like. The transportable component may be configured to be delivered to or released at the location, region, proximity or the like of the swelling material. In this way, the transportable component, when delivered or released may encourage separation of an emulsion at the location, region, proximity or the like of the swelling material.

The swelling seal may comprise a support member. The support member may comprise a tubular, such as an oilfield tubular. The tubular may comprise casing, liner, production tubing, coiled tubing, drill pipe, collars or the like. The sealing material may be mounted on the support member. The de-emulsifying component may be mounted on the support member, for example directly mounted, indirectly mounted or the like.

The support member may comprise a sleeve.

The de-emulsifying component may be configured to be delivered trough the support member.

The swelling seal may define a downhole seal. The seal may define a packer.

The swelling seal may be configured for use in zonal isolation. The swelling seal may be configured for use in a compartmentalized fracing operation.

The swelling seal may be configured for use at an interface between first and second components, such as first and second tubular bodies. The swelling seal may be configured to provide a seal at a connection between first and second components, such as a threaded connection.

According to a second aspect of the present invention there is provided a method of establishing a seal, comprising:
locating a swelling seal having a swellable material within an emulsion comprising an activator medium;
separating at least one constituent phase from the emulsion;
permitting the swelling seal to swell.

The method may comprise separating the activating medium from the emulsion.

The swelling seal may be provided in accordance with the first aspect.

The method may comprise locating the swelling seal within a wellbore.

The method may comprise locating the swelling seal within a manufactured emulsion, such as a drilling mud. The method may comprise locating the swelling seal within an emulsion formed of fluids from a subterranean reservoir.

According to a third aspect of the present invention there is provided a downhole seal comprising:
a support body;
a seal body mounted on the support body, wherein the seal body comprises a swellable material configured to swell upon exposure to an activator medium; and
a de-emulsifying component configured to encourage separation of at least one constituent phase from an emulsion comprising an activator medium.

The de-emulsifying component may be formed with or mounted on or within the seal body. The de-emulsifying component may comprise a coating. The de-emulsifying component may comprise a component dispersed throughout the swelling material. The de-emulsifying component may comprise a fluid, solid or any combination thereof. The de-emulsifying component may comprise an apparatus.

The term “drilling mud” has been used herein as an example of an emulsion. It should be understood, however, that a drilling mud is generally used as a term of art, and is not necessarily provided exclusively for drilling operations. For example, a drilling mud may be utilised for operations and functions such as wellbore pressure control, hydraulic power, reservoir pressure control/stimulus, fracing operations, well killing and the like. Also, although drilling muds have been defined as including water and/or oil, other compositions are available.

### BRIEF DESCRIPTION OF THE DRAWINGS

These and other aspects of the present invention will now be described, by way of example only, with reference to the accompanying drawings, in which:

FIG. 1A is diagrammatic representation of a swelling seal in accordance with one embodiment of the present invention, shown in use in an initial configuration;

FIG. 1B is a diagrammatic representation of the swelling seal of FIG. 1A, shown in use to separate constituent phases of an emulsion;

FIG. 1C is a diagrammatic representation of the swelling seal of FIG. 1A shown in a swollen configuration;

FIG. 2 is a diagrammatic representation of a swelling seal in accordance with an alternative embodiment of the present invention; and

FIG. 3 is a diagrammatic representation of a swelling seal in accordance with a further alternative embodiment of the present invention.

### DETAILED DESCRIPTION OF THE PREFERRED EMBODIMENTS

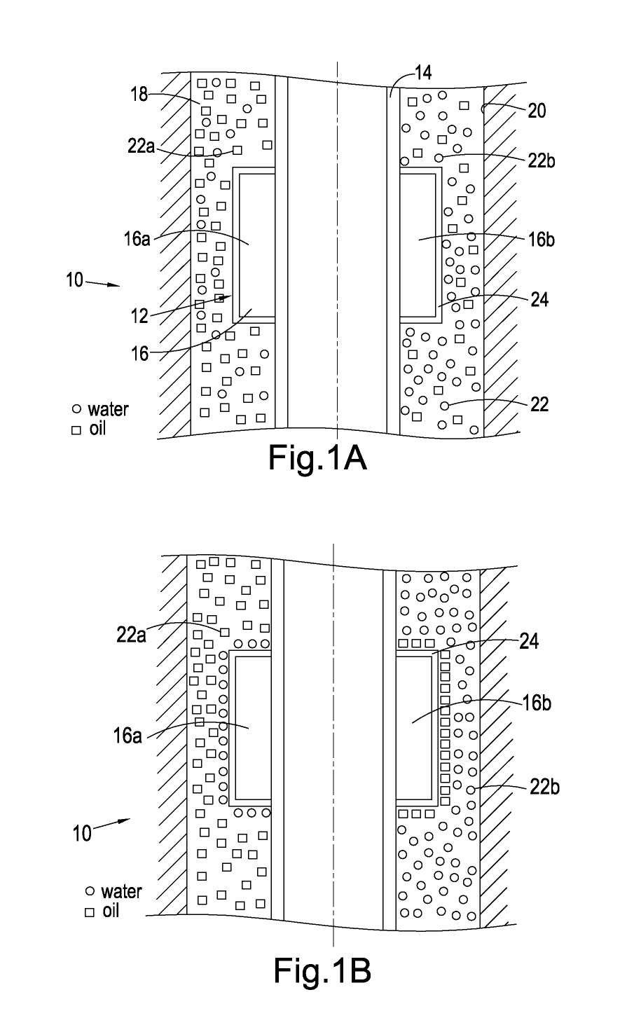

FIG. 1A shows a swelling seal, generally identified by reference numeral 10, in accordance with one embodiment of the present invention. The seal 10 includes a seal body 12 which is mounted on a tubular body 14, wherein the seal body 12 includes a swellable material 16. The seal 10 is shown located within a wellbore 18, and as will be described in detail below the swellable material 16 of the seal body 12 is configured to swell upon exposure to an activator medium to establish a seal between the tubing 14 and a wall 20 of the wellbore 18.

The seal 10 is shown immersed within an emulsion. The seal has application in different types of emulsion 22, and to demonstrate this while maintaining brevity of the present description, an invert mud emulsion 22a is represented on the left side of FIG. 1A, and a water based mud emulsion 22b is represented on the right side of FIG. 1A. An invert mud includes oil as the continuous phase and water as the internal phase, and a water based mud includes water as the continuous phase and oil as the internal phase.

Typically, swelling seals for use in invert muds have necessarily contained oil swelling materials, as water swelling materials would be substantially inert in such an emulsion type, as the water is trapped within the oil. Similarly, swelling seals for use in water based muds have necessarily contained water swelling materials, as oil swelling materials would be substantially inert. The present invention addresses this issue.

As noted above, the seal body 12 includes a swellable material 16. The left side of FIG. 1A illustrates use of a water swelling material 16a, and the right side of FIG. 1A illustrates an oil swelling material 16b, again for brevity of the present description.

The seal body 12 further includes a de-emulsifying component 24 in the form of a coating which covers the swellable material 16 and which is configured to encourage separation of the emulsion 22 within which the seal body 12 is immersed. The de-emulsifying component 24, in the embodiment shown, includes an ionic composition configured to encourage separation of the emulsion 22. As illustrated in FIG. 1B, the de-emulsifying component 24 separates and frees the water from the invert mud 22a, and separates and frees the oil from the water based mud 22b. Accordingly, the respective free water and oil will become available to activate swelling of the appropriate swelling material 16a, 16b, as demonstrated in FIG. 1C.

Accordingly, the present invention advantageously permits a swelling material to be utilised within an emulsion in which the activating medium defines the internal phase.

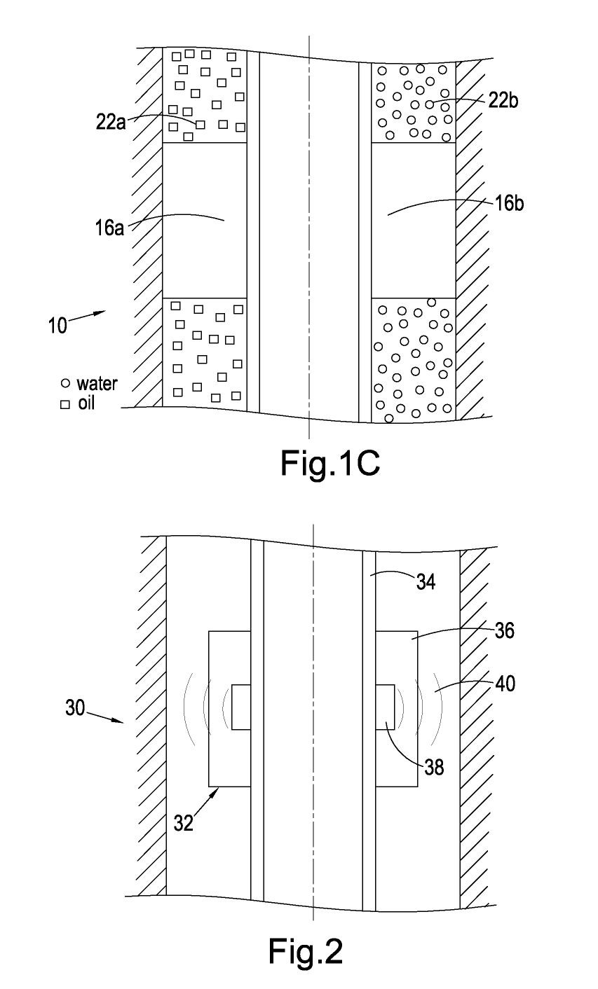

An alternative embodiment of a swelling seal is shown in FIG. 2, reference to which is now made. In this embodiment the swelling seal, generally identified by reference numeral 30, includes a seal body 32 mounted on a tubular 34. The seal body includes a swellable material 36 configured to swell upon exposure to an activator medium. The seal 30 further comprises a de-emulsifying component in the form of a de-emulsifying apparatus 38 which, in the embodiment shown, forms part of the seal body 32 and is embedded within the swellable material 36.

The de-emulsifying apparatus 38 is configured to provide an output, generally represented by numeral 40, which output 40 encourages separation of an emulsion to free a suitable activator medium to cause swelling of the swellable material 32. The output 40 may comprise a high potential alternating electrical field.

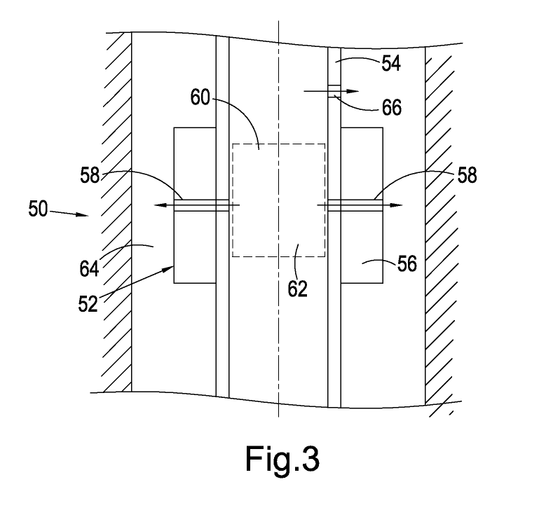

A further alternative embodiment is shown in FIG. 3, reference to which is now made. In this embodiment a swelling seal, generally identified by reference numeral 50 includes a seal body 52 mounted on a tubular 54. The seal body includes a swellable material 56 configured to swell upon exposure to an activator medium. A number of ports 58 are provided through the seal body 52 and tubular 54 and communicate with a source 60 of a de-emulsifying fluid 62. When required, the fluid 62 is ejected from the ports 58 and into an annulus 64 to encourage separation of an emulsion within the annulus 64 to free a suitable activator medium to cause swelling of the swellable material 56.

It should be understood that the embodiments described above are merely exemplary and that various modifications may be made thereto without departing from the scope of the present invention. For example, in the embodiment shown in FIG. 1 the de-emulsifying component is provided as a coating. However, the de-emulsifying component may be dispersed within the swelling material, for example.

Additionally, in the embodiment shown in FIG. 2 the de-emulsifying apparatus is embedded within the seal body. However, in alternative arrangements the de-emulsifying apparatus may be provided separately of the seal body.

In the embodiment of FIG. 3 the de-emulsifying fluid is ejected through ports in the seal body. However, the fluid may alternatively or additionally be ejected through ports which are remote from the seal body, for example through a port 66 identified in FIG. 3.

Furthermore, in each embodiment a particular type of de-emulsifying component is presented. In other embodiments two or more of the disclosed arrangements may be used in combination.

I Claim:

1. A swelling seal comprising:
a swellable material configured to swell upon exposure to an activator medium; and
a de-emulsifying component configured to encourage separation of at least one constituent phase from an emulsion comprising an activator medium.

2. The swelling seal according to claim 1, wherein the de-emulsifying component is configured to encourage separation of an activator medium from an emulsion.

3. The swelling seal according to claim 1, wherein the de-emulsifying component is configured to encourage separation of an activator medium which defines an internal phase of an emulsion.

4. The swelling seal according to claim 1, wherein the de-emulsifying component is configured to encourage separation of at least one constituent phase from an emulsion comprising two or more constituent phases.

5. The swelling seal according to claim 1, wherein the de-emulsifying component is configured to separate at least one constituent phase from an emulsion comprising at least one of water and oil.

6. The swelling seal according to claim 1, wherein the de-emulsifying component is configured to encourage separation of at least one constituent phase from an emulsion which comprises fluids produced from a subterranean reservoir containing at least one of water and hydrocarbons.

7. The swelling seal according to claim 1, wherein the de-emulsifying component is configured to encourage separation of at least one constituent phase from an emulsion which comprises a manufactured emulsion.

8. The swelling seal according to claim 7, wherein the manufactured emulsion comprises a wellbore fluid.

9. The swelling seal according to claim 7, wherein the manufactured emulsion comprises an oil based mud.

10. The swelling seal according to claim 7, wherein the manufactured emulsion comprises a water based mud.

11. The swelling seal according to claim 1, wherein the de-emulsifying component comprises an ionic composition.

12. The swelling seal according to claim 1, wherein the de-emulsifying component comprises a charge configured to attract a constituent phase of an emulsion.

13. The swelling seal according to claim 1, wherein the de-emulsifying component is intimately dispersed throughout the swelling material.

14. The swelling seal according to claim 1, wherein the de-emulsifying component comprises a coating configured to at least partially cover the swelling material.

15. The swelling seal according to claim 1, wherein the de-emulsifying component comprises an apparatus configured to provide an output for encouraging separation of an emulsion.

16. The swelling seal according to claim 15, wherein the output comprises at least one of an acoustic output, an electromagnetic output and a mechanical output.

17. The swelling seal according to claim 1, wherein the de-emulsifying component comprises a transportable component.

18. The swelling seal according to claim 17, wherein the transportable component is configured to be delivered to or released at a location of the swelling material.

19. The swelling seal according to claim 1, comprising a support member configured to support the swellable material.

20. The swelling seal according to claim 19, wherein the support member comprises a tubular.

21. The swelling seal according to claim 19, wherein the de-emulsifying component is configured to be delivered trough the support member.

22. The swelling seal according to claim 1, configured to define a downhole packer.

23. A method of establishing a seal, comprising:
locating a swelling seal having a swellable material within an emulsion comprising an activator medium;
separating at least one constituent phase from the emulsion;
permitting the swelling seal to swell.

24. The method according to claim 23, comprise separating the activating medium from the emulsion.

25. The method according to claim 23, comprising locating the swelling seal within a wellbore.

26. A downhole seal comprising:
a support body;
a seal body mounted on the support body, wherein the seal body comprises a swellable material configured to swell upon exposure to an activator medium; and
a de-emulsifying component configured to encourage separation of at least one constituent phase from an emulsion comprising an activator medium.
